(19) United States
(12) Patent Application Publication
(10) Pub. No.: US 2025/0109218 A1
(43) Pub. Date: Apr. 3, 2025

(54) METHOD FOR PREPARING CATALYST COMPONENT FOR POLYMERIZATION OF POLYOLEFIN WITHOUT THE USE OF INTERNAL ELECTRON DONORS

(71) Applicant: Formosa Plastics Corporation, U.S.A., Livingston Township, NJ (US)

(72) Inventors: Demin Xu, Port Lavaca, TX (US); Guangxue Xu, Port Lavaca, TX (US); Cyrus C.Y. Lee, Victoria, TX (US); Chih-Jian Chen, Port Lavaca, TX (US)

(21) Appl. No.: 18/477,901

(22) Filed: Sep. 29, 2023

(51) Int. Cl. C08F 4/645

(52) U.S. Cl. CPC C08F 4/6455

(57) ABSTRACT

This present invention relates to a method for using halogenation agents to react with magnesium precursor or with magnesium complexes to form catalyst components without using internal electron donors. The catalyst components are used to produce polypropylene with good productivity and high stereospecificity. This method offers a wide range of catalyst component preparations and selections to enhance the catalyst component applications regarding activity, stereospecificity, hydrogen response, molecular weight, and distributions.

### BACKGROUND

The present invention relates to Ziegler-Natta catalyst components for olefin polymerizations by employing halogenation agents to contact with magnesium precursors/supports/complexes to form catalyst components with or without at least one or more internal donor compounds, to methods of making such polymerization catalysts, and to polymerization processes to produce polyolefins, including homo-polymers and copolymers, having high activities, good regularity controls and a wide range of molecular weight distributions. This method may be used to produce polyolefin catalyst without using any internal donors, especially for polypropylene catalysts with high activity and good stereospecificity.

The applications of Ziegler-Natta catalyst systems for olefin polymerizations are well known in the art. Commonly, these catalysts are composed of a solid Ziegler-Natta catalyst component and a co-catalyst component, usually an organoaluminum compound, and/or an external electron donor to be used in the catalyst system. The Ziegler-Natta catalyst components consist of magnesium, halide, titanium and modifiers, which have electron donating groups and have been widely employed to increase the activity and stereospecificity of polymerization catalyst system.

It is known that highly stereospecific and highly active catalyst components with spherical shapes and uniform particles result in powdery polymers having a more satisfactory granular shape, a narrower particle size distribution, and higher bulk density, to thereby facilitate the fluidity of the produced powders, to increase productivity, and to eliminate the fine powders of polymers and to reduce the process clogging. U.S. Pat. No. 3,953,414 describes these catalyst component applications, which result in olefin polymers having spheroidal particles and controlled particle size distributions. The activity and stereospecificity of such catalysts, however, still need to be improved to meet the commercial practice.

To prepare solid catalyst components with good morphology and bulk density, solid precursors/supports are commonly used, including magnesium halides, organic magnesium compounds, magnesium halide-silica-gel composites, magnesium halide-clay composites, polymer composites, and magnesium halide adducts. The preferred precursors/supports are magnesium chloride, dialkoxy magnesium, chloroalkoxy magnesium and magnesium halide adducts. Examples of such precursors and their applications in catalyst component preparations are described in U.S. Pat. Nos. 3,901,863; 4,109,071; 4,220,554; 4,472,521; 4,547,476; 4,617,360; 4,816,433; 4,855,271; 5,075,270; 5,547,912; 5,849,655; 5,965,478; 7,329,626; 7,601,423; 7,879,751; 7,989,382; 8,546,290; 9,206,273; 10,000,589; and 10,113,014; and CN106674389, each of which is incorporated for reference herein in its entirety.

U.S. Pat. Nos. 4,617,360 and 4,109,071 describe the catalyst components made from the precursors of combined compositions comprising halogen- and oxygen-containing magnesium compounds. Typical examples of these compositions are basic magnesium halides (preferably chlorides) and magnesium compounds containing both a magnesium/halogen bond and an organic radical, which is as defined above and is bonded to the magnesium via the oxygen, including chloroalkoxides and chlorophenoxides such as Mg(OCH₃)Cl, Mg(OC₂H₅)Cl, and Mg(OC₆H₅)Cl. U.S. Pat. No. 5,965,478 discloses the catalyst components prepared from the precursor diethoxymagnesium having good bulk density, spherical shapes, specific surface area and pore distributions, narrow particle size distributions, and less fine powders. The obtained polymers also have high bulk density, less fine powders, high activities, and high stereoregularity, especially for the production of copolymers and block copolymers.

U.S. Pat. No. 9,815,918 discloses magnesium complexes containing acid salts of group IB-VIIIB elements, which are prepared by co-crystallization or solidification from a solution containing both magnesium halide represented by formula MgXₙ(OR)₂₋ₙ and acid salts of group IB-VIIIB elements represented by formula MₘYₚ and are further treated with internal electron donor and titanium compound to form the catalyst components. The modifications of catalyst supports or precursors can improve the catalyst performance in terms of activity and stereo-specificity.

WO 2015/177733 discloses catalyst components prepared from magnesium powders by reacting with alcohol to form magnesium alkoxide, which is used as supports, and further treated with internal donors and titanium compound to convert into the magnesium chloride catalyst components. After two treatments with titanium compound, the solid components are further treated with titanium compound and benzoyl chloride to obtain a pro-catalyst. In this step, a second internal donor ethyl benzoate was formed in-situ. It is undetermined that second internal donor ethyl benzoate is formed due to the fact that two chlorination agents titanium compound and benzoyl chloride have different reactiveness and second internal donor ethyl benzoate has impact on the properties of catalysts and polypropylenes. This method shows the fines of catalyst components are high and the morphology control of catalyst components needs to be improved.

U.S. Pat. No. 7,902,108, EP1273595, and the Journal of Molecular Catalysis A: Chemical 278 (2007), at 127-134 each disclose a process for making catalyst components by reacting a magnesium complex solution, prepared by adding a solution in toluene of BOMAG-A™ [i.e., Mg(Bu)₁₋₅ (Oct)_{0.5}]into 2-ethylhexanol, phthaloyl chloride, and chlorobutane, with titanium compound to form a emulsion, and then an acrylic polymer is used to stabilize the emulsion and to solidify the particles forming the dispersed phase. The three-step process of catalyst preparation relates to making magnesium alkoxide solution, reacting with phthaloyl chloride to form the magnesium complex and treating with titanium compound. To increase the magnesium alkoxide solubility and to form solution, the alcohols have long branch substitutes, which results in controlling the catalyst morphology such as particle size, distribution, and shape, and having limitations of internal donor in-situ formations. The catalyst performance of activity and stereoregularity are still low, especially in propylene polymerizations.

U.S. Pat. No. 9,593,183 discloses a method by reacting anhydrous magnesium dichloride with 2,4-pentanediol and/or 3-ethyl-2,4-pentanediol to dissolve magnesium dichloride in decane and a benzoyl halide compound to prepare magnesium dichloride solution, which is further treated with titanium compound twice to prepare solid components. Phthaloyl dichloride is used in comparative examples and catalysts show low activities and high xylene extractions. During the catalyst component preparations, the magnesium dichloride is dissolved to make solutions and then the catalyst components are precipitated from the solution. However, the catalyst preparations related to the controls of catalyst formation, such as particle size and distribution and shapes, still have limitations regarding of stirring speed control, temperature increase speed, and chemical adding speed. The catalyst performance of activity and stereoregularity still need to be improved.

WO 2016/168108 discloses a process for preparing a solid catalyst component by dissolving the magnesium dichloride in toluene, epichlorohydrin and tributyl phosphate to make a solution, and further contacting with titanium compound, phthaloyl chloride as an auxiliary donor, and internal donors. The results demonstrate that the addition of the auxiliary donor to the support improves the magnesium dichloride surface by blocking atactic sites, but does not significantly affect the catalyst activity. The internal donor typically generates isotactic polymerization sites on catalyst support providing the high catalytic activity for the polymerization process. Atactic sites may be present in the catalyst resulting in undesirable polymer properties such as soluble atactic and low molecular weight polymer fractions. The combination of the auxiliary donor and the internal donor provides for a synergistic effect of the catalyst performance by blocking atactic sites and modifying the isotactic sites due to the competition between coordination on catalyst surface, and the ability to be removed by alkyl aluminum and external donors. The auxiliary donors are acyl halides and the internal electron donors are an ester, an ether, a ketone, or a combination thereof. The xylene soluble contents still need to be improved, which indicates the isotacticity of polymers is not high enough for high flexible modulus applications.

These modifiers, which are also named internal donors, are commonly used to control catalyst formations and particle size and shapes, to improve catalyst and polymerization performance including the activity, stereoregularity, hydrogen response, molecular weight, and molecular weight distributions, and to impact the final product physical properties. Acceptable modifiers, which are used in the solid Ziegler-Natta catalyst components during preparation of such catalysts, include organic compounds containing O, Si, N, S, and/or P, such as acyl chloride, esters, ethers, ketones, amines, alcohols, phenols, phosphorous compounds, and silicon compounds.

Examples of such modifiers acyl chloride and their use as components of the catalyst system, including buret t-butyl chloride, butyl chloride, phathaloyl chloride and benzoyl chloride are described in U.S. Pat. Nos. 4,260,709; 4,766,100; 9,896,523; 9,068,025; 2017/0051086; 4,246,384; 4,379,898; 4,535,068; 4,710,482; 4,711,940; 4,766,100; 4,804,648; 4,806,696; 4,855,371; 5,130,284; 7,582,415; 5,147,839; 7,651,946; 6,825,146; 7,026,265; 7,265,074; 7,902,108; 8,633,124; 8,962,774; 9,040,444; 9,115,223; 9,593,183; and 9,605,089; and DE 3,017,571; WO 2014/081132; WO 2015/177733; WO 2016/168108; EP 0197310, EP 0361371; EP 1273595; CN 104558279 and CN 104558280; each of which is incorporated for reference herein in its entirety.

Examples of other modifiers and their use as a component of the catalyst system, including phthalates, diol esters, diethers, and succinates, are described in U.S. Pat. Nos. 4,107,414; 4,186,107; 4,226,963; 4,347,160; 4,382,019; 4,435,550; 4,465,782; 4,530,912; 4,532,313; 4,560,671; 4,657,882; 5,106,807; 5,208,302; 5,723,400; 5,902,765; 5,948,872; 6,121,483; 6,436,864; 6,605,562; 6,770,586; 6,683,017; 6,818,583; 6,822,109; 6,825,309; 7,022,640; 7,049,377; 7,202,314; 7,208,435; 7,223,712; 7,324,431; 7,351,778; 7,371,802; 7,388,061; 7,420,021; 7,491,781; 7,544,748; 7,674,741; 7,674,943; 7,888,437; 7,888,438; 7,964,678; 8,003,558; 8,003,559; 8,088,872; 8,211,819; 8,222,357; 8,227,370; 8,236,908; 8,247,341; 8,263,520; 8,263,692; 8,288,304; 8,288,585; 8,318,626; 8,383,540; 8,470,941; 8,536,290; 8,569,195; 8,575,283; 8,604,146; 8,633,126; 8,692,927; 8,664,142; 8,680,222; 8,716,417; 8,716,514; 8,740,947; 9,156,927; 9,790,291; 9,815,918; 2018/0051105A1; and 9,815,920; and in EP 0437263; EP 0361493; EP 1042372; EP 1088009; EP 1478617; EP 2159232; EP 2345675; EP 2610273; EP 2794676; and EP 2799456, each of which is incorporated for reference herein in its entirety.

In the utilization of Ziegler-Natta type catalysts for polymerizations involving propylene or other olefins, for which isotacticity is a possibility, it may be desirable to utilize an external electron donor, and acceptable external electron donors include organic compounds containing O, Si, N, S, and/or P. Such compounds include organic acids, organic acid esters, organic acid anhydrides, ethers, ketones, alcohols, aldehydes, silanes, amides, carbonate, amines, amine oxides, thiols, various phosphorus acid esters and amides, etc. Preferred external electron donors are organosilicon compounds containing Si—O—C and/or Si—N—C bonds, having silicon as the central atom. Such compounds are described in EP 0350170; EP 0460590; EP 0576411; EP 0601496; EP 0641807; and EP 1538167; and in U.S. Pat. Nos. 4,472,524; 4,473,660; 4,560,671; 4,581,342; 4,657,882; 5,106,807; 5,407,883; 5,684,173; 6,228,961; 6,362,124; 6,552,136; 6,689,849; 7,009,015; 7,244,794; 7,276,463; 7,619,049; 7,790,819; 8,247,504; 8,648,001; and 8,614,162, each of which is incorporated by reference herein in its entirety. U.S. Pat. No. 6,271,310 listed carbonate as one of potential external donor that may be used for propylene polymerization.

There is a continuing need for developing catalyst systems that can be used to produce polyolefins, particularly polypropylene, with good hydrogen response to obtain a high melt flow product. In addition to good hydrogen response, desired catalyst systems should also offer good polymerization activity and a steady and wide operating window for controlling isotacticity of the resulting polymers based on end user application requirements.

### SUMMARY OF THE INVENTION

In accordance with the objectives of this invention, there is provided a Ziegler-Natta catalyst component useful for the polymerization of olefins, which is obtained by a process contacting a magnesium precursor/complexes with at least one of halogenation agent, with and/or without internal electron donors, and with at least one titanium compound.

A method used to prepare a catalyst component comprises the reactions between a magnesium precursor and halogenation agents to form internal donors in situ, which is used to modify the magnesium precursors and to improve the performance of catalyst component, and the reactions among the magnesium precursor, internal donors and titanium compounds. The catalyst components can be used produce polypropylene polymers with good activity, and stereo-regularity and good morphology, which is adopted from the magnesium precursors.

A method offers a wide range of catalyst component preparations and selections to enhance the catalyst component applications regarding activity, stereo-specificity, hydrogen response, molecular weight and distributions, final product physical property of polyolefins, particularly polypropylene and its copolymers, which consequently increases the product physical properties.

### DESCRIPTION OF PREFERRED EMBODIMENTS

The present invention provides a solid catalyst component for the polymerization of olefins CH₂═CHR in which R is hydrogen or a C-12 hydrocarbyl, comprising of magnesium, titanium, halogen, and one or more electron donors. Catalyst components of the present invention can be prepared by a method contacting magnesium precursor (A) with at least one halogenation agent (B), with and/or without internal electron donors, and with at least one titanium compound (C).

Magnesium precursor (A) consists of solid compounds, solid particles, solid powders, and/or solid composites containing R¹OMgOR² or R¹OMgX, in which these solid materials include salts, silica gel, clays, polymers etc. are not otherwise limited. R¹ and R² are independent groups, which may be identical or different, and are selected from aliphatic, aromatic, alicyclic, heteroaliphatic, heteroaromatic, or heteroalicyclic groups. The length and structure of R¹ and R² are not otherwise limited and R¹ and R² may link with each other to form polyols. In preferred embodiments of the present invention, R¹ and R² are C1-C20 alkyls. X is a halogen atom.

Halogenation agents (B) react with the magnesium precursors to form internal donors in situ and to modify the magnesium precursors, and are selected from acid chloride, carbonyl chloride, oxalyl chloride, phosphoryl chloride, phosphinic acid chloride, phosphonic dichloride, phosphonic dichloride, chloridophosphate, chlorothiophosphate, sulfuryl chloride, sulfonyl halide, thionyl chloride, chlorosulfate, chlorosulfate, silicon chloride, and chlorosilane.

According to a preferred embodiment of the present invention, internal electron donors may also be used to make the catalyst components either as a single compound or as combination with two or more compounds. Internal electron donors are organic compounds containing O, Si, N, S, and/or P, such as alcohol, esters, ethers, ketones, amines, alcohols, phenols, phosphines and silanes. Of this group of compounds, the preferred internal electron donors are 1,3-diethers, malonates, succinates, phthalic acid esters, esters of aliphatic or aromatic diols, or their derivatives.

In one embodiment of present invention, before or after further contacting with halogenation agents (B) and internal donors, magnesium precursor (A) is treated with a magnesium halide solution and/or a magnesium complex solution, which is formed by dissolving magnesium halide, acid salts of group IB-VIIIB and chemical reagents together in a solvent. For example, magnesium chloride (MgX₂) and transition metal halide (MₘYₚ) can be dissolved together in hydrocarbon solvents or hetero hydrocarbon solvents to form a treating solution. As another example, transition metal halide (MₘYₚ) can be dissolved in hydrocarbon solvents or hetero hydrocarbon solvents to form a treating solution. These examples are illustrative only, and can be prepared as discussed in U.S. Pat. No. 9,815,918, which is incorporated by reference herein in its entirety.

In another embodiment of present invention, magnesium complex (A) contains a percentage of MgXOR and/or Mg(OR)₂ in the range from about 5% to about 100%. For example, the molar ratio between Mg(OR)₂ and metal halide (MₘYₚ) is preferably in the range from about 100% to about 5%, more preferably in the range from about 90% to about 8%, illustrated by the example molar ratios between Mg(OR)₂—MgCl₂ are preferably from about 100 to about 10 in magnesium complex (A).

According to a preferred embodiment of the present invention, alcohols can also be used to make the catalyst component, either as a single compound or as combination with two or three compounds, including, but not limited to, mono alcohol, diol, and polyols.

Titanium compound (C), having a general formula Ti(OR)_{q}X_{4-q}, where X is a halogen atom. R may be independent groups, which may be identical or different, and are selected from aliphatic, aromatic, alicyclic, heteroaliphatic, heteroaromatic, or heteroalicyclic groups. The length and structure of R is not otherwise limited. X is a halogen atom, and q is an integer from 0 to 4. In preferred embodiments of the present invention, R is a C1-C20 alkyl and q=0. Preferred titanium compounds of the general formula Ti(OR)_{q}X_{4-q} that can be employed for the present invention include:
[1]titanium tetrahalides, such as TiCl₄, TiBr₄ and TiI₄;
[2]alkoxytitanium trihalides, such as Ti(OCH₃)Cl₃, Ti(OC₂H₅)Cl₃, Ti(O-n-C₄H₉)Cl₃, Ti(OC₂H₅)Br 3 and Ti(O-iso-C₄H₉)Br₃;
[3]dialkoxytitanium dihalides, such as Ti(OCH₃)₂Cl₂, Ti(OC₂H₅)₂Cl₂, Ti(O-n-C₄H₉)₂Cl₂, and Ti(OC₂H₅)₂Br₂;
[4]trialkoxytitanium monohalides, such as Ti(OCH₃)₃Cl, Ti(OC₂H₅)₃Cl, Ti(O-n-C₄H₉)₃Cl and Ti(OC₂H₅)₃Br;
[5]tetraalkoxytitaniums, such as Ti(OCH₃)₄, Ti(OC₂H₅)₄, Ti(O-n-C₄H₉)₄, Ti(O-iso-C₄H₉)₄ and Ti(O-2-ethylhexyl); and
[6]other compounds such as Ti[O—C(CH₃)CH—CO—CH]₂Cl₂, Ti[N(C₂H₅)₂]Cl₃, Ti[N(C₆H₅)₂]Cl₃, Ti(C₆H₅COO)Cl₃, [N(C₄H₉)₄]₂TiCl₆, [N(CH₃)₄]Ti₂Cl₉, TiBr₄, TiCl₃OSO₂C₆H₅, and LiTi(OC₃H₇)₂Cl₃.

Preferred co-catalyst component includes aluminum alkyl compounds. Acceptable aluminum alkyl compounds include aluminum trialkyls, such as aluminum triethyl, aluminum triisobutyl, and aluminum triisopropyl. Other acceptable aluminum alkyl compounds include aluminum-dialkyl hydrides, such as aluminum-diethyl hydrides. Other acceptable co-catalyst components include compounds containing two or more aluminum atoms linked to each other through hetero-atoms, such as:
(C₂H₅)₂Al—O—Al(C₂H₅)₂;
(C₂H₅)₂Al—N(C₆H₅)—Al(C₂H₅)₂; and
(C₂H₅)₂Al—O—SO₂—O—Al(C₂H₅)₂.

According to one embodiment, the catalyst component of the present invention is combined with the aforementioned silicon compound and an organoaluminium compound for the polymerization of olefins. The organoaluminium compound is used in a molar ratio of from about 1 to about 1000 per atom of titanium in the catalyst component, and the silicon compound is used in a molar ratio of less than about 1, preferably from about 0.005 to about 0.5 per mole of the organoaluminium compound. The molecular weight of the polymers may be controlled by known methods, preferably by using hydrogen. With the catalyst component produced according to the present invention, molecular weight may be suitably controlled with hydrogen when the polymerization is carried out at relatively low temperatures, e.g., from about 30° C. to about 105° C. This control of molecular weight may be evidenced by a measurable positive change of the Melt Flow Rate (MFR).

Acceptable external electron donor component includes organic compounds containing O, Si, N, S, and/or P. Such compounds include organic acids, organic acid esters, organic acid anhydrides, ethers, ketones, alcohols, aldehydes, silanes, amides, amines, amine oxides, thiols, various phosphorus acid esters, and amides, etc. Preferred external electron donors are organosilicon compounds containing Si—O—C and/or Si—N—C bonds. Some examples of such organosilicon compounds are trimethylmethoxysilane, diphenyldimethoxysilane, cyclohexylmethyldimethoxysilane, diisopropyldimethoxysilane, dicyclopentyldimethoxysilane, isobutyltriethoxysilane, vinyltrimethoxysilane, dicyclohexyldimethoxysilane, 3-tert-Butyl-2-isobutyl-2methoxy-[1,3,2]oxazasilolidine, 3-tert-Butyl-2-cyclopentyl-2-methoxy-[1,3,2]oxazasilolidine, 2-Bicyclo[2.2.1]hept-5-en-2-yl-3-tert-butyl-2-methoxy-[1,3,2]oxazasilolidine, 3-tert-Butyl-2,2-diethoxy-[1,3,2]oxazasilolidine, 4,9-Di-tert-butyl-1,6-dioxa-4,9-diaza-5-sila-spiro[4.4]nonane, bis(perhydroisoquinolino) dimethoxysilane, etc. Mixtures of organic electron donors may also be used. Finally, the oxalic acid diamides of the present invention may also be employed as an external electroni donor. Other organosilicon compounds, which may be used as internal donors and external donors, can be found in U.S. Pat. Nos. 7,619,049; 7,790,819; 8,575,283; 9,790,291; 9,951,152; and 10,124,324, each of which is incorporated by reference herein in its entirety. These external donors may be used herein either individually or jointly.

The catalyst component of the present invention is not limited by polymerization process, and polymerization of olefins may be performed in the presence of, or in the absence of, an organic solvent. Olefin monomers may be used in the gaseous or liquid state depending on the polymerization as slurry, liquid or gas phase processes, or in a combination of liquid and gas phase processes using separate reactors, all of which can be done either by batch or continuously. The polyolefin may be directly obtained from a gas phase process, or obtained by isolation and recovery of solvent from a slurry process, according to conventionally known methods. The olefin monomer can be added prior to, with, or after the addition of the Ziegler-Natta type catalyst system to the polymerization reactor.

The Ziegler-Natta type catalyst systems of the present invention are useful in the polymerization of olefins, including but not limited to homopolymerization and copolymerization of alpha olefins. Suitable α-olefins that may be used in a polymerization process in accordance with the present invention include olefins of the general formula CH₂═CHR, where R is H or C₁₋₁₀ straight or branched alkyl, such as ethylene, propylene, butene-1, pentene-1, 4-methylpentene-1 and octene-1. While the Ziegler-Natta type catalyst systems of the present invention may be employed in processes in which ethylene is polymerized, it is more desirable to employ the Ziegler-Natta type catalyst systems of the present invention in processes in which polypropylene or higher olefins are polymerized. Processes involving the homopolymerization or copolymerization of propylene are preferred.

### EXAMPLES

In order to provide a better understanding of the present invention, the following non-limiting examples are listed below. Although the examples may be directed to specific embodiments, in no way should the following examples be read to limit or define the entire scope of the invention.

GC/MS was used to characterize, determine, and monitor the changes of compounds and reaction progress. The instrument information is incorporated herein by reference. The GC/MS measurement (Gas Chromatograph with Mass Spectrometry) was from Agilent 7890B gas-chromatography, Agilent G4567A auto-injector and Agilent 5977A mass spectra detector.

The solid catalyst composition and polymers in the examples were tested according to the methods described herein. The following analytical methods were used to characterize the polymer.

PP heptane insoluble (HC7-I %): 15-20 g of the fully dried polymer was extracted with refluxing heptane for 8 hours and the weight percent (wt %) of polymer residuals was collected and fully dried to calculate HC7-I %.

PE hexane insoluble (HC6-I %): 15-20 g of the fully dried polymer was extracted with refluxing hexane for 6.5 hours and the weight percent (wt %) of polymer residuals was collected and fully dried to calculate HC6-I %.

Diisopropyldimethoxysilane (P-donor) was purchased from Gelest, Inc. of Morrisville, Pa., USA, and 5-tert-butyl-3-methylbenzene-1,2-diol was purchased from Aurum Pharmatech.

Magnesium ethoxide (98%), magnesium chloride(98%), anhydrous toluene (99.8%), anhydrous n-heptane (99%), titanium tetrachloride (99.0%), triethyl aluminum(93%), benzoyl chloride (99%), phthaloyl dichloride (98%), diethylmalonyl dichloride (98%), succinic acid dichloride (95.0%), ethyl alcohol (anhydrous 99.5%), isobutyl alcohol(99%), 2,4-pentanediol (98%), diisobutyl phthalate (99%), diethyl phthalate (99.5%), diethyl diethylmalonate (98%), diethyl succinate (99%), tributyl phosphate (99%) and epichlorohydrin (99%) were all purchased from Sigma-Aldrich Co. of Milwaukee, Wis., USA. 2,4-diisobutyldibenzoate was prepared according to U.S. Patent No. 2018/0051105 A1.

Hydrogen (99.999%) was purchased from Airgas. Methanol (99.9%) was purchased from Fox Scientific Inc.

The activity values (AC) were based upon grams of polymer produced per gram of solid catalyst component used.

PP MFR (melt flow rate) was conducted according to ASTM D-1238 at 230° C. with a load of 2.16 kg.

PE MFR (melt flow rate) was conducted according to ASTM D-1238 at 190° C. with a load of 2.16 kg.

Unless otherwise indicated, all reactions were conducted under an inert atmosphere.

### Example 1

### (A) Preparation of a Solid Catalyst Component

To a three-neck 250 ml flask equipped with a stirrer and thermometer, which was thoroughly purged with anhydrous nitrogen, 10.0 g of magnesium ethoxide and 80 ml of anhydrous toluene was introduced to form a suspension and the mixture was heated to gradually raise temperature to 60° C. 1.8 g isobutanol and 2.3 g phthaloyl chloride, dissolved in anhydrous toluene 15 ml, were slowly added through a stainless steel cannula. The mixture of magnesium ethoxide, phthaloyl chloride and isobutanol were stirred at 60° C. for 3 hours, which was monitored with GC-MS until the peak of phthaloyl chloride disappeared. The mixture was cooled to room temperature and kept overnight.

The mixture was cooled below −20° C. and 30 ml TiCl₄ was slowly added. The mixture was slowly heated to 80° C. and stirred for 2 hours. The hot mixture was transferred into a Schlenk type reactor equipped with a mechanical and a fritted filter disc, which was heated and maintained at the temperature 110° C. The resulting solid was filtered and washed twice with 40 ml of anhydrous toluene at 100° C. 80 ml of fresh anhydrous toluene and 25 ml TiCl₄ was added to the filtered solid and then the mixture was heated to 110° C. and stirred for 2 hours.

The mixture was filtered and the resulting solid washed twice with 40 ml of anhydrous toluene at 100° C. 80 ml of fresh anhydrous toluene and 25 ml TiCl₄ was added to the filtered solid, and then the mixture was heated to 110° C. and stirred for 2 hours.

The residual solid was filtered and washed with anhydrous toluene three times at 90° C., and then with anhydrous heptane twice at 90° C. and one time at ambient temperature. The final catalyst component was collected and dried under vacuum to obtain a solid composition.

### (B) Propylene Slurry Polymerization

Propylene was polymerized using a laboratory scale 2 liter stainless steel autoclave equipped with a stirrer and a jacket for heating and cooling, which was heated to a temperature above 100° C. to expel all traces of moisture and air with a nitrogen purge. After allowing the reactor to cool to 50° C. under nitrogen, one liter of anhydrous heptane was introduced into the autoclave, successively followed by adding 2.5 mmol of triethyl aluminum, and then 0.2 mmol of diisopropyldimethoxysilane (P-donor), and then about 30.0 mg of the solid catalyst obtained above. The autoclave was kept at 50° C. and the pressure of autoclave was controlled about 5.0 psig with nitrogen. Hydrogen in a 150 ml vessel with a pressure of 8 psig was flushed into the reactor with propylene.

The reactor was then raised to 70° C. and the total reactor pressure was raised to 90 psig by feeding propylene. The reaction was maintained for 1 hour under this condition with a continuous propylene feed to maintain a constant pressure during the course of the polymerization. The system was then cooled to 50° C. and vented to reduce the pressure to 0 psig. The reactor was opened and 500 ml methanol was added to the reactor and the resulting mixture was stirred for 10 minutes and then filtered to obtain the polymer. The obtained polymer was dried under vacuum at 80° C. for 6 hours. The polymer was weighed and tested with melt flow rate (MFR) and PP heptane insoluble (HC7-I %). The results were listed in Table 1.

### (C) Ethylene Slurry Polymerization

Ethylene was polymerized using a laboratory scale 2 liter stainless steel autoclave equipped with a stirrer and a jacket for heating and cooling, which was heated to a temperature above 100° C. to expel all traces of moisture and air with a nitrogen purge. After allowing the reactor to cool to 60° C. under nitrogen, one liter of anhydrous hexane was introduced into the autoclave. Autoclave temperature was elevated to 650 C, 1 mmol of triethyl aluminum and 20.0 mg of the solid catalyst obtained were added successively into the autoclave. Autoclave temperature was raised to 85° C. with stirring. The system, which was at a pressure of 29 psi (2 bar) from vapor pressure of the hexane with adjusting of nitrogen pressure, was pressurized with hydrogen to a total pressure of 85 psi and then followed ethylene to a total pressure of 145 psi to initiate polymerization.

The reaction was maintained for 1 hour under this condition with a continuous ethylene feed to maintain a constant total pressure during the course of the polymerization. After the reaction mixture was cooled below 50° C. and about 500 ml methanol was added into the mixture. After stirred for 10 minutes, the resulting polymer was separated by filtration and dried under reduced pressure at 80° C. for 5 hrs. The polymers were weighed and tested with melt flow rate (MFR) and Hexane Insoluble (HC6-I %), listed in Table 2.

### Example 2

### (A) Preparation of a Solid Catalyst Component

To a three-neck 250 ml flask equipped with a stirrer and thermometer, which was thoroughly purged with anhydrous nitrogen, 10.0 g of magnesium ethoxide and 80 ml of anhydrous toluene was introduced to form a suspension and the mixture was heated to gradually raise temperature to 80° C. 1.8 g isobutanol and 2.3 g phthaloyl chloride, dissolved in anhydrous toluene 10 ml, were slowly added through a stainless steel cannula. The mixture of magnesium ethoxide, phthaloyl chloride and isobutanol were stirred at 80° C. for 2 hours, which was monitored with GC-MS until the peak of phthaloyl chloride disappeared. The mixture was cooled to room temperature and kept overnight.

After the solution of 1.15 g epichlorohydrin and 3.0 g tributylphosphate, dissolved in anhydrous toluene 15 ml, were added into the mixture through a stainless steel cannula, the mixture was heated to 50° C., and stirred for 1.5 hours. The mixture was cooled below −20° C. and 30 ml TiCl₄ was slowly added. The mixture was slowly heated to 80° C. and stirred for 2 hours. The hot mixture was transferred into a Schlenk type reactor equipped with a mechanical and a fritted filter disc, which was heated and maintained at the temperature 110° C. The resulting solid was filtered and washed twice with 40 ml of anhydrous toluene at 100° C. 80 ml of fresh anhydrous toluene and 25 ml TiCl₄ was added to the filtered solid and then the mixture was heated to 110° C. and stirred for 2 hours.

The mixture was filtered and the resulting solid washed twice with 40 ml of anhydrous toluene at 100° C. 80 ml of fresh anhydrous toluene and 25 ml TiCl₄ was added to the filtered solid, and then the mixture was heated to 110° C. and stirred for 2 hours.

The residual solid was filtered and washed with anhydrous toluene three times at 90° C., and with anhydrous heptane twice at 90° C. and one time at ambient temperature. The final catalyst component was collected and dried under vacuum to obtain a solid composition.

### (B) Propylene Slurry Polymerization

Propylene polymerization procedure of Example 2 was the same as described in Example 1. The polymers were weighed and tested with melt flow rate (MFR) and PP heptane insoluble (HC7-I %). The results were listed in Table 1.

### (C) Ethylene Slurry Polymerization

Ethylene polymerization procedure of Example 2 was the same as described in Example 1. The polymers were weighed and tested with melt flow rate (MFR) and PE hexane insoluble (HC6-I %). The results were listed in Table 2.

### (D) Propylene Bulk Polymerization

Propylene bulk polymerization was conducted in a laboratory scale liter stainless steel autoclave equipped with a stirrer and a jacket for heating and cooling, which was heated to a temperature above 100° C. to expel all traces of moisture and air with a nitrogen purge. After allowing the reactor to cool to 70° C. under nitrogen, 3 mmol of triethyl aluminum and 0.25 mmol of diisopropyldimethoxysilane (P-donor) were introduced into the autoclave, successively followed by adding about 7 mg of the solid catalyst obtained above, and then hydrogen, and then 1.2 liter of liquefied propylene to start the polymerization. The reaction was maintained for 1 hour under this condition with stirring. The system was then stopped heating and vented to reduce the pressure to 0 psi. The obtained polymer was dried under vacuum at 80° C. for 6 hours. The polymer was weighed and tested with melt flow rate (MFR) and PP heptane insoluble (HC7-I %). The results were listed in Table 3.

### Example 3

The catalyst component was prepared by following the procedure of Example 2 except that 3.6 g isobutanol and 4.6 g phthaloyl chloride were used to react with 10.0 g of magnesium ethoxide at 60° C. and that 2.3 g epichlorohydrin and 6.0 g tributylphosphate was used. The final catalyst was collected and dried under vacuum to obtain a solid composition.

Propylene slurry polymerization procedure of Example 3 was the same as described in Example 1. The polymers were weighed and tested with melt flow rate (MFR) and PP heptane insoluble (HC7-I %). The results were listed in Table 1.

Ethylene slurry polymerization procedure of Example 3 was the same as described in Example 1. The polymers were weighed and tested with melt flow rate (MFR) and PE hexane insoluble (HC6-I %). The results were listed in Table 2.

### Example 4

The catalyst component was prepared by following the procedure of Example 2 except that 0.46 g isobutanol and 2.5 g phthaloyl chloride were used to react with 10.0 g of magnesium ethoxide at 60° C. The final catalyst was collected and dried under vacuum to obtain a solid composition.

Propylene slurry polymerization procedure of Example 4 was the same as described in Example 1. The polymers were weighed and tested with melt flow rate (MFR) and PP heptane insoluble (HC7-I %). The results were listed in Table 1.

Ethylene slurry polymerization procedure of Example 4 was the same as described in Example 1. The polymers were weighed and tested with melt flow rate (MFR) and PE hexane insoluble (HC6-I %). The results were listed in Table 2.

### Comparative Example 1

### (A) Preparation of a Solid Catalyst Component

To a three-neck 250 ml flask equipped with a stirrer and thermometer, which was thoroughly purged with anhydrous nitrogen, 10.0 g of magnesium ethoxide and 100 ml of anhydrous toluene was introduced to form a suspension. 25 ml TiCl₄ was slowly added into the mixture at room temperature. The mixture was heated to gradually raise temperature to 45° C., and then 3.1 g diisobutyl phthalate was added. The temperature of mixture was slowly increased to 110° C. and maintained for 2 hours with stirring.

The hot mixture was transferred into a Schlenk type reactor equipped with a mechanical and a fritted filter disc, which was heated and maintained at the temperature 100° C. The resulting solid was filtered and washed twice with 40 ml of anhydrous toluene at 100° C. 80 ml of fresh anhydrous toluene and 25 ml TiCl₄ was added to the filtered solid and then the mixture was heated to 110° C. and stirred for 2 hours.

The residual solid was filtered and washed with anhydrous toluene three times at 90° C., and with anhydrous heptane twice at 90° C. and one time at ambient temperature. The final catalyst component was collected and dried under vacuum to obtain a solid composition.

### (B) Propylene Slurry Polymerization

Propylene polymerization procedure of Comparative Example 1 was the same as described in Example 1. The polymers were weighed and tested with melt flow rate (MFR) and PP heptane insoluble (HC7-I %). The results were listed in Table 1.

### (C) Ethylene Slurry Polymerization

Ethylene polymerization procedure of Comparative Example 1 was the same as described in Example 1. The polymers were weighed and tested with melt flow rate (MFR) and PE hexane insoluble (HC6-I %). The results were listed in Table 2.

### (D) Propylene Bulk Polymerization

Propylene bulk polymerization procedure of Comparative Example 1 was the same as described in Example 2. The polymers were weighed and tested with melt flow rate (MFR) and PP heptane insoluble (HC7-I %). The results were listed in Table 3.

TABLE 1
PP slurry polymerizations

| | AC | MFR | HC7-I % |
|---|---|---|---|
| Examples | (gPP/gCat) | (g/10 min) | (%) |
| Ex. 1 | 5516.7 | 1.1 | 99.0 |
| Ex. 2 | 8753.3 | 0.7 | 99.3 |
| Ex. 3 | 4380.0 | 1.3 | 98.9 |
| Ex. 4 | 5670.0 | 0.9 | 99.2 |
| Com. Ex. 1 | 5336.7 | 2.1 | 98.7 |

TABLE 2
PE slurry polymerizations

| | AC | MFR | HC6-I |
|---|---|---|---|
| Examples | (gPP/gCat) | (g/10 min) | (%) |
| Ex. 1 | 5911.8 | 6.4 | 99.6 |
| Ex. 2 | 7113.3 | 8.0 | 99.8 |
| Ex. 3 | 4214.6 | 2.7 | 99.6 |
| Ex. 4 | 5217.8 | 9.3 | 99.6 |
| Com. Ex. 1 | 3149.3 | 2.5 | 99.7 |

TABLE 3
PP bulk polymerizations

| | AC | MFR | HC7-I |
|---|---|---|---|
| Examples | (gPP/gCat) | (g/10min) | (%) |
| Ex. 2 | 50285.7 | 1.5 | 98.8 |
| Com. Ex. 1 | 30200.0 | 7.1 | 98.4 |

### Example 5

### (A) Preparation of a Solid Catalyst Component

To a three-neck 250 ml flask equipped with a stirrer and thermometer, which was thoroughly purged with anhydrous nitrogen, 10.0 g of magnesium ethoxide and 100 ml of anhydrous toluene was introduced to form a suspension and the mixture was heated to gradually raise temperature to 80° C. 1.15 g 2,4-pentane diol and 3.7 g benzoyl chloride, dissolved in anhydrous toluene 10 ml, were slowly added through a stainless steel cannula. The mixture of magnesium ethoxide, benzoyl chloride and 2,4-pentane diol were stirred at 80° C. for 10 minutes, and then stirred at 100° C. for 4 hours, which was monitored with GC-MS until the peak of benzoyl chloride disappeared. The mixture was cooled to room temperature and kept overnight.

The mixture was stirred at room temperature and 30 ml TiCl₄ was slowly added. The mixture was slowly heated to 100° C. and stirred for 2 hours. The hot mixture was transferred into a Schlenk type reactor equipped with a mechanical and a fritted filter disc, which was heated and maintained at the temperature 110° C. The resulting solid was filtered and washed twice with 40 ml of anhydrous toluene at 100° C. 80 ml of fresh anhydrous toluene and 25 ml TiCl₄ was added to the filtered solid and then the mixture was heated to 110° C. and stirred for 2 hours.

The residual solid was filtered and washed with anhydrous toluene three times at 90° C., and with anhydrous heptane twice at 90° C. and one time at ambient temperature. The final catalyst component was collected and dried under vacuum to obtain a solid composition.

### (B) Propylene Slurry Polymerization

Propylene slurry polymerization procedure of Example 5 was the same as described in Example 1. The polymers were weighed and tested with melt flow rate (MFR) and PP heptane insoluble (HC7-I %). The results were listed in Table 4.

### (C) Ethylene Slurry Polymerization

Ethylene polymerization procedure of Example 5 was the same as described in Example 1. The polymers were weighed and tested with melt flow rate (MFR) and PE hexane insoluble (HC6-I %). The results were listed in Table 5.

### Example 6

The catalyst component was prepared by following the procedure of Example 5 except that 1.15 g 2,4-pentane diol and 3.4 g benzoyl chloride were used to react with 10.0 g of magnesium ethoxide at 120° C. for 20 minutes. The final catalyst was collected and dried under vacuum to obtain a solid composition.

Propylene polymerization procedure of Example 6 was the same as described in Example 1. The polymers were weighed and tested with melt flow rate (MFR) and PP heptane insoluble (HC7-I %). The results were listed in Table 4.

Ethylene slurry polymerization procedure of Example 6 was the same as described in Example 1. The polymers were weighed and tested with melt flow rate (MFR) and PE hexane insoluble (HC6-I %). The results were listed in Table 5.

### Example 7

To a three-neck 250 ml flask equipped with a stirrer and thermometer, which was thoroughly purged with anhydrous nitrogen, 10.0 g of magnesium ethoxide and 80 ml of anhydrous toluene was introduced to form a suspension and the mixture was heated to gradually raise temperature to 60° C. 1.15 g 2,4-pentane diol and 3.3 g benzoyl chloride, dissolved in anhydrous toluene 10 ml, were slowly added through a stainless steel cannula. The mixture of magnesium ethoxide, 3.3 g benzoyl chloride and 2,4-pentane diol were stirred at 60° C. for 3 hours, which was monitored with GC-MS until the peak of benzoyl chloride disappeared. The mixture was cooled to room temperature and kept overnight.

The following procedure of Example 7 was the same as described in Example 2. The final catalyst was collected and dried under vacuum to obtain a solid composition.

Propylene slurry polymerization procedure of Example 7 was the same as described in Example 1. The polymers were weighed and tested with melt flow rate (MFR) and PP heptane insoluble (HC7-I %). The results were listed in Table 4.

Ethylene slurry polymerization procedure of Example 7 was the same as described in Example 1. The polymers were weighed and tested with melt flow rate (MFR) and PE hexane insoluble (HC6-I %). The results were listed in Table 5.

### Example 8

The catalyst component was prepared by following the procedure of Example 7 except that except that 1.5 g 2,4-pentane diol and 4.3 g benzoyl chloride were used to react with 10.0 g of magnesium ethoxide at 50° C. for 6 hours. The final catalyst was collected and dried under vacuum to obtain a solid composition.

Propylene slurry polymerization procedure of Example 8 was the same as described in Example 1. The polymers were weighed and tested with melt flow rate (MFR) and PP heptane insoluble (HC7-I %).The results were listed in Table 4.

Ethylene slurry polymerization procedure of Example 8 was the same as described in Example 1. The polymers were weighed and tested with melt flow rate (MFR) and PE hexane insoluble (HC6-I %). The results were listed in Table 5.

### Comparative Example 2

The catalyst component was prepared by following the procedure of Comparative Example 1 except that 3.2 g 2,4-pentanediol dibenzoate was added when the mixture was heated to gradually raise temperature to 40° C. The final catalyst was collected and dried under vacuum to obtain a solid composition.

Propylene slurry polymerization procedure of Comparative Example 6 was the same as described in Example 1. The polymers were weighed and tested with melt flow rate (MFR) and PP heptane insoluble (HC7-I %). The results were listed in Table 4.

Ethylene slurry polymerization procedure of Comparative Example 2 was the same as described in Example 1. The polymers were weighed and tested with melt flow rate (MFR) and PE hexane insoluble (HC6-I %). The results were listed in Table 5.

TABLE 4
PP slurry polymerizations

| | AC | MFR | HC7-I % |
|---|---|---|---|
| Examples | (gPP/gCat) | (g/10 min) | (%) |
| Ex. 5 | 2420.0 | 6.0 | 97.5 |
| Ex. 6 | 1823.3 | 3.5 | 97.4 |
| Ex. 7 | 8786.7 | 1.1 | 97.8 |
| Ex. 8 | 4030.0 | 3.7 | 96.3 |
| Com. Ex. 2 | 1346.7 | 5.4 | 95.8 |

TABLE 5
PE slurry polymerizations

| | AC | MFR | HC6-I |
|---|---|---|---|
| Examples | (gPP/gCat) | (g/10 min) | (%) |
| Ex. 5 | 7288.6 | 8.4 | 99.2 |
| Ex. 6 | 4519.6 | 9.4 | 99.7 |
| Ex. 7 | 9541.5 | 13.9 | 99.1 |
| Ex. 8 | 5098.5 | 11.6 | 98.7 |
| Com. Ex. 2 | 2512.3 | 6.2 | 99.7 |

### Example 9

### (A) Preparation of a Solid Catalyst Component

To a three-neck 250 ml flask equipped with a stirrer and thermometer, which was thoroughly purged with anhydrous nitrogen, 10.0 g of magnesium ethoxide, 2.5 g diethylmalonyl dichloride and 100 ml of anhydrous toluene was introduced to form a suspension. The mixture was stirred at room temperature overnight, and then heated to 70° C. and stirred for 3 hours, which was monitored with GC-MS until the peak of diethylmalonyl dichloride. The mixture was stirred at 90° C. for 3 hours, and then stirred at 105° C. for 6 hours. The mixture was cooled to room temperature and kept overnight.

After the solution of 1.2 g epichlorohydrin and 3.1 g tributylphosphate, dissolved in anhydrous toluene 15 ml, were added into the mixture through a stainless steel cannula, the mixture was heated to 50° C., and stirred for 3 hours. The mixture was cooled in ice bath and 30 ml TiCl₄ was slowly added. The mixture was slowly heated to 80° C. and stirred for 2 hours. The hot mixture was transferred into a Schlenk type reactor equipped with a mechanical and a fritted filter disc, which was heated and maintained at the temperature 110° C. The resulting solid was filtered and washed twice with 40 ml of anhydrous toluene at 100° C. 80 ml of fresh anhydrous toluene and 25 ml TiCl₄ was added to the filtered solid, and then the mixture was heated to 110° C. and stirred for 2 hours.

The mixture was filtered and the resulting solid washed twice with 40 ml of anhydrous toluene at 100° C. 80 ml of fresh anhydrous toluene and 25 ml TiCl₄ was added to the filtered solid, and then the mixture was heated to 110° C. and stirred for 2 hours.

The residual solid was filtered and washed with anhydrous toluene three times at 90° C., and with anhydrous heptane twice at 90° C. and one time at ambient temperature. The final catalyst component was collected and dried under vacuum to obtain a solid composition.

### (B) Propylene Slurry Polymerization

Propylene polymerization procedure of Comparative Example 9 was the same as described in Example 1. The polymers were weighed and tested with melt flow rate (MFR) and PP heptane insoluble (HC7-I %). The results were listed in Table 6.

### (C) Ethylene Slurry Polymerization

Ethylene polymerization procedure of Example 9 was the same as described in Example 1. The polymers were weighed and tested with melt flow rate (MFR) and PE hexane insoluble (HC6-I %). The results were listed in Table 7.

### Comparative Example 3

The catalyst component was prepared by following the procedure of Comparative Example 1 except that 2.7 diethyl diethylmalonate was added instead of 3.1 g diisobutyl phthalate when the mixture was heated to gradually raise temperature to 80° C. The final catalyst was collected and dried under vacuum to obtain a solid composition.

Propylene slurry polymerization procedure of Comparative Example 3 was the same as described in Example 1. The polymers were weighed and tested with melt flow rate (MFR) and PP heptane insoluble (HC7-I %). The results were listed in Table 6.

Ethylene slurry polymerization procedure of Comparative Example 3 was the same as described in Example 1. The polymers were weighed and tested with melt flow rate (MFR) and PE hexane insoluble (HC6-I %). The results were listed in Table 7.

### Example 10

The catalyst component was prepared by following the procedure of Example 9 except that only 1.8 g succinyl chloride instead of 2.5 g diethylmalonyl dichloride was used to react with 10.0 g of magnesium ethoxide at 50° C. for 4 hours. The final catalyst was collected and dried under vacuum to obtain a solid composition.

Propylene slurry polymerization procedure of Example 10 was the same as described in Example 1. The polymers were weighed and tested with melt flow rate (MFR) and PP heptane insoluble (HC7-I %). The results were listed in Table 6.

Ethylene slurry polymerization procedure of Example 10 was the same as described in Example 1. The polymers were weighed and tested with melt flow rate (MFR) and PE hexane insoluble (HC6-I %). The results were listed in Table 7.

### Comparative Example 4

The catalyst component was prepared by following the procedure of Comparative Example 1 except that 1.9 g diethylsuccinate was added instead of 3.1 g diisobutyl phthalate when the mixture was stirred in ice bath during TiCl₄ adding. The final catalyst was collected and dried under vacuum to obtain a solid composition.

Propylene slurry polymerization procedure of Comparative Example 4 was the same as described in Example 1. The polymers were weighed and tested with melt flow rate (MFR) and PP heptane insoluble (HC7-I %). The results were listed in Table 6.

Ethylene slurry polymerization procedure of Comparative Example 4 was the same as described in Example 1. The polymers were weighed and tested with melt flow rate (MFR) and PE hexane insoluble (HC6-I %). The results were listed in Table 7.

TABLE 6
PP slurry polymerizations

| | AC | MFR | HC7-I % |
|---|---|---|---|
| Examples | (gPP/gCat) | (g/10 min) | (%) |
| Ex. 9 | 3586.7 | 7.1 | 94.0 |
| Com. Ex. 3 | 1736.7 | 21.4 | 96.3 |
| Ex. 10 | 2316.7 | 2.7 | 97.7 |
| Com. Ex. 4 | 1023.3 | 6.5 | 97.0 |

TABLE 7
PE slurry polymerizations

| | AC | MFR | HC6-I |
|---|---|---|---|
| Examples | (gPP/gCat) | (g/10 min) | (%) |
| Ex. 9 | 8848.0 | 5.4 | 99.7 |
| Com. Ex. 3 | 1668.3 | 5.8 | 99.8 |
| Ex. 10 | 4828.4 | 3.5 | 99.8 |
| Com. Ex. 4 | 1872.6 | 4.3 | 99.3 |

### Example 11

### (A) Preparation of a Solid Catalyst Component

To a three-neck 250 ml flask equipped with a stirrer and thermometer, which was thoroughly purged with anhydrous nitrogen, 10.0 g of magnesium ethoxide and 50 ml of anhydrous toluene was introduced to form a suspension. 2.3 g 5-tert-butyl-3-methylbenzene-1,2-diol and 1.9 g benzoyl chloride, dissolved in anhydrous toluene 30 ml, were slowly added through a stainless steel cannula. The mixture was stirred at room temperature for 4.5 hours, which was monitored with GC-MS until the peak of benzoyl chloride disappeared. The mixture was gradually heated to 90° C. and stirred for 2.5 hours, and then 2.2 g benzoyl chloride was added. The mixture was stirred at 90° C. for 2 hours. The mixture was cooled to room temperature and kept overnight.

The mixture was cooled to room temperature and 20 ml TiCl₄ was slowly added. The mixture was slowly heated to 100° C. and stirred for 2 hours. The hot mixture was transferred into a Schlenk type reactor equipped with a mechanical and a fritted filter disc, which was heated and maintained at temperature 110° C. The resulting solid was filtered and washed twice with 40 ml of anhydrous toluene at 100° C. 80 ml of fresh anhydrous toluene and 25 ml TiCl₄ was added to the filtered solid and then the mixture was heated to 110° C. and stirred for 2 hours.

The mixture was filtered and the resulting solid washed twice with 40 ml of anhydrous toluene at 100° C. The mixture was filtered and the resulting solid washed twice with 40 ml of anhydrous toluene at 100° C. 80 ml of fresh anhydrous toluene and 25 ml TiCl₄ was added to the filtered solid, and then the mixture was heated to 110° C. and stirred for 2 hours.

The residual solid was filtered and washed with anhydrous toluene three times at 90° C., and with anhydrous heptane twice at 90° C. and one time at ambient temperature. The final catalyst component was collected and dried under vacuum to obtain a solid composition.

### (B) Propylene Slurry Polymerization

Propylene polymerization procedure of Example 11 was the same as described in Example 1. The polymers were weighed and tested with melt flow rate (MFR) and PP heptane insoluble (HC7-I %). The results were listed in Table 8.

### (C) Ethylene Slurry Polymerization

Ethylene polymerization procedure of Example 11 was the same as described in Example 1. The polymers were weighed and tested with melt flow rate (MFR) and PE hexane insoluble (HC6-I %). The results were listed in Table 9.

### Example 12

The catalyst component was prepared by following the procedure of Example 11 except that the mixture of 1.8 g 5-tert-butyl-3-methylbenzene-1,2-diol and 1.9 g benzoyl chloride was added and the mixture was heated at 100° C. and stirred for 1 hour. The final catalyst was collected and dried under vacuum to obtain a solid composition.

Propylene slurry polymerization procedure of Example 12 was the same as described in Example 1. The polymers were weighed and tested with melt flow rate (MFR) and PP heptane insoluble (HC7-I %). The results were listed in Table 8.

Ethylene slurry polymerization procedure of Comparative Example 12 was the same as described in Example 1. The polymers were weighed and tested with melt flow rate (MFR) and PE hexane insoluble (HC6-I %). The results were listed in Table 9.

### Example 13

The catalyst component was prepared by following the procedure of Example 11 except that the mixture of 1.8 g 5-tert-butyl-3-methylbenzene-1,2-diol and 3.1 g benzoyl chloride was added and the mixture was heated at 80° C. and stirred for 3 hour. The final catalyst was collected and dried under vacuum to obtain a solid composition.

Propylene slurry polymerization procedure of Example 13 was the same as described in Example 1. The polymers were weighed and tested with melt flow rate (MFR) and PP heptane insoluble (HC7-I %). The results were listed in Table 8.

Ethylene slurry polymerization procedure of Comparative Example 13 was the same as described in Example 1. The polymers were weighed and tested with melt flow rate (MFR) and PE hexane insoluble (HC6-I %). The results were listed in Table 9.

### Example 14

### (A) Preparation of a Solid Catalyst Component

To a three-neck 250 ml flask equipped with a stirrer and thermometer, which was thoroughly purged with anhydrous nitrogen, 10.0 g of magnesium ethoxide, 1.15 g 2,4-pentane diol and 80 ml of anhydrous toluene was introduced to form a suspension. The mixture was heated to 100° C. and the mixture of 2.44 g benzoyl chloride and 1.37 g diphenylphosphinic chloride dissolved in 30 ml toluene was added slowly. The mixture was stirred for 30 minutes at 100° C. and the mixture was cooled to room temperature and kept overnight.

The following procedure of Example 14 was same as the preparation of Example 11. The final catalyst was collected and dried under vacuum to obtain a solid composition.

### (B) Propylene Slurry Polymerization

Propylene polymerization procedure of Example 14 was the same as described in Example 1. The polymers were weighed and tested with melt flow rate (MFR) and PP heptane insoluble (HC7-I %). The results were listed in Table 8.

### (C) Ethylene Slurry Polymerization

Ethylene polymerization procedure of Example 14 was the same as described in Example 1. The polymers were weighed and tested with melt flow rate (MFR) and PE hexane insoluble (HC6-I %). The results were listed in Table 9.

### Example 15

### (A) Preparation of a Solid Catalyst Component

To a three-neck 250 ml flask equipped with a stirrer and thermometer, which was thoroughly purged with anhydrous nitrogen, 10.0 g of magnesium ethoxide, 1.15 g 2,4-pentane diol and 80 ml of anhydrous toluene was introduced to form a suspension. The mixture was heated to 100° C. and 1.3 g diphenylphosphinic chloride dissolved in 10 ml toluene was added first. After the mixture was stirred at 100° C. for 5 minutes, 2.44 g benzoyl chloride was added. The mixture was stirred at 100° C. for 2 hours and was cooled to room temperature and kept overnight.

The following procedure of Example 15 was same as the preparation of Example 11. The final catalyst was collected and dried under vacuum to obtain a solid composition.

### (B) Propylene Slurry Polymerization

Propylene polymerization procedure of Example 15 was the same as described in Example 1. The polymers were weighed and tested with melt flow rate (MFR) and PP heptane insoluble (HC7-I %). The results were listed in Table 8.

### (C) Ethylene Slurry Polymerization

Ethylene polymerization procedure of Example 15 was the same as described in Example 1. The polymers were weighed and tested with melt flow rate (MFR) and PE hexane insoluble (HC6-I %). The results were listed in Table 9.

TABLE 8
PP slurry polymerizations

| | AC | MFR | HC7-I % |
|---|---|---|---|
| Examples | (gPP/gCat) | (g/10 min) | (%) |
| Ex. 11 | 3250.0 | 5.0 | 94.5 |
| Ex. 12 | 3170.0 | 4.8 | 95.7 |
| Ex. 13 | 2823.3 | 6.0 | 96.0 |
| Ex. 14 | 2106.7 | 6.9 | 96.6 |
| Ex. 15 | 1926.7 | 5.2 | 94.8 |

TABLE 9
PE slurry polymerizations

| | AC | MFR | HC6-I |
|---|---|---|---|
| Examples | (gPP/gCat) | (g/10 min) | (%) |
| Ex. 11 | 6403.9 | 10.0 | 99.6 |
| Ex. 12 | 7644.2 | 9.6 | 99.4 |
| Ex. 13 | 8960.4 | 10.2 | 99.6 |
| Ex. 14 | 2990.2 | 15.4 | 99.8 |
| Ex. 15 | 5874.4 | 6.0 | 99.5 |

### Example 16

### (A) Preparation of a Solid Catalyst Component

To a three-neck 250 ml flask equipped with a stirrer and thermometer, which was thoroughly purged with anhydrous nitrogen, 10.0 g of magnesium ethoxide, 1.55 g benzoyl dichloride and 100 ml of anhydrous toluene was introduced to form a suspension. The mixture was stirred at room temperature for 40 minutes, and then heated to 50° C. and stirred for 6 hours, which was monitored with GC-MS until the peak of benzoyl dichloride. The mixture was cooled to room temperature and kept overnight.

After the solution of 0.7 g epichlorohydrin and 1.7 g tributylphosphate, dissolved in anhydrous toluene 15 ml, were added into the mixture through a stainless steel cannula, the mixture was heated to 50° C., and stirred for 3 hours. The mixture was cooled in ice bath and 20 ml TiCl₄ was slowly added. The mixture was slowly heated to 105° C. and stirred for 3.5 hours. The hot mixture was transferred into a Schlenk type reactor equipped with a mechanical and a fritted filter disc, which was heated and maintained at the temperature 100° C. The resulting solid was filtered and washed twice with 40 ml of anhydrous toluene at 100° C. 80 ml of fresh anhydrous toluene and 5 ml TiCl₄ was added to the filtered solid, and then the mixture was heated to 107° C. and stirred for 1 hour.

The mixture was filtered and washed with anhydrous toluene three times at 90° C., and with anhydrous heptane twice at 90° C. and one time at ambient temperature. The final catalyst component was collected and dried under vacuum to obtain a solid composition.

### (B) Ethylene Slurry Polymerization

Ethylene polymerization procedure of Example 16 was the same as described in Example 1. The polymers were weighed and tested with melt flow rate (MFR) and PE hexane insoluble (HC6-I %). The results were listed in Table 10.

### Example 17

The catalyst component was prepared by following the procedure of Example 16 except that 0.7 g epichlorohydrin was added instead of the mixture of 0.7 g epichlorohydrin and 1.7 g tributylphosphate and the mixture was heated at 50° C. and stirred for 3 hours. The final catalyst was collected and dried under vacuum to obtain a solid composition.

Ethylene slurry polymerization procedure of Example 17 was the same as described in Example 1. The polymers were weighed and tested with melt flow rate (MFR) and PE hexane insoluble (HC6-I %). The results were listed in Table 10.

### Example 18

The catalyst component was prepared by following the procedure of Example 16 except that 2.5 g diethylmalonyl dichloride instead of 1.55 g benzoyl dichloride is added, and the mixture was heated to 105° C. and stirred for 5 hours, and 1.2 g epichlorohydrin were added instead of 0.7 g epichlorohydrin and 1.7 g tributylphosphate. The final catalyst was collected and dried under vacuum to obtain a solid composition.

Ethylene slurry polymerization procedure of Example 18 was the same as described in Example 1. The polymers were weighed and tested with melt flow rate (MFR) and PE hexane insoluble (HC6-I %). The results were listed in Table 10.

TABLE 10
PE slurry polymerizations

| | AC | MFR | HC6-I |
|---|---|---|---|
| Examples | (gPP/gCat) | (g/10 min) | (%) |
| Ex. 16 | 4465.7 | 9.6 | 99.2 |
| Ex. 17 | 5759.8 | 17.0 | 99.5 |
| Ex. 18 | 4839.0 | 5.3 | 99.6 |

As the above data demonstrate, the polymerization of olefins using the invented method to prepare catalyst component fulfills the requirements of present invention. With the reaction between magnesium precursor and halogenation agents, it is now possible to achieve polyolefin catalyst components having high stereo-regularity and/or high polymerization activity without any internal donors. For example, the catalyst component of Example 2 exhibited higher heptane insoluble and higher polymerization activity compared with Comparative Example 1. The similar results are also found between Example 7 and Comparative Example 2, Example 9 and Comparative Example 3, and Example 10 and Comparative Example 4. As such, the present inventive catalyst system offers more application flexibility and a broader approach to prepare catalyst components for polyolefin production.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Whenever a numerical range with a lower limit and an upper limit is disclosed, any number falling within the range is specifically disclosed. Moreover, the indefinite articles “a” or “an”, as used in the claims, are defined herein to mean one or more than one of the element that it introduces.

What is claimed is:

1. A method for preparing a catalyst component for the polymerization or co-polymerization of alpha-olefin, comprising:
providing one or more magnesium precursor (A);
providing one or more halogenation agents (B);
providing one or more titanium compound (C) have a general formula Ti(OR²)qX4-q, wherein X is a halogen atom and R² is independently selected from aliphatic, aromatic, alicyclic, heteroaliphatic, heteroaromatic, or heteroalicyclic groups, wherein q is an integer from 0 to 4; and
reacting the one or more magnesium precursor (A) with the one or more halogenation agents (B) to form a modified magnesium precursor; and
reacting the modified magnesium precursor with the one or more titanium compound (C) to form the catalyst component.

2. The method of claim 1, wherein the one or more magnesium precursor (A) comprises R¹OMgOR², wherein R¹ and R² are independently selected from aliphatic, aromatic, alicyclic, heteroaliphatic, heteroaromatic, or heteroalicyclic groups, and wherein R¹ and R² may link with each other to form polyols.

3. The method of claim 1, wherein the one or more magnesium precursor (A) comprises R¹OMgX, wherein X is a halogen atom, and wherein R¹ is selected from aliphatic, aromatic, alicyclic, heteroaliphatic, heteroaromatic, or heteroalicyclic groups.

4. The method of claim 1, wherein the one or more magnesium precursor (A) comprises magnesium ethoxide.

5. The method of claim 1, wherein the one or more halogenation agents (B) is selected from acid chloride, carbonyl chloride, oxalyl chloride, phosphoryl chloride, phosphinic acid chloride, phosphonic dichloride, phosphonic dichloride, chloridophosphate, chlorothiophosphate, sulfuryl chloride, sulfonyl halide, thionyl chloride, chlorosulfate, silicon chloride, and chlorosilane.

6. The method of claim 1, wherein the one or more halogenation agents (B) comprises phthaloyl chloride.

7. The method of claim 1, wherein the one or more halogenation agents (B) comprises benzoyl chloride.

8. The method of claim 1, wherein the one or more halogenation agents (B) comprises diethylmalonyl dichloride.

9. The method of claim 1, wherein the titanium compound (C) comprises TiCl₄.

10. The method of claim 1, further comprising providing one or more internal electron donors comprising O, Si, N, S, and/or P; and further comprising reacting the one or more magnesium precursor (A) with the one or more halogenation agents (B), the one or more internal electron donors, and the one or more titanium compound (C) to form the catalyst component.

11. The method of claim 1, wherein one or more organic solvents may be used to dissolve halogenation agents (B) prior to the reacting step, wherein the one or more organic solvents is selected from hydrocarbon solvents and heteroatom substituted hydrocarbon solvents.
